(19) United States
(12) Patent Application Publication
(10) Pub. No.: US 2017/0124829 A1
(43) Pub. Date: May 4, 2017

(54) Attached Garage and Attic Fire Detector

(71) Applicant: Charles Joseph Tennies, Waukesha, WI (US)

(72) Inventor: Charles Joseph Tennies, Waukesha, WI (US)

(21) Appl. No.: 15/338,438

(22) Filed: Oct. 30, 2016

Related U.S. Application Data
(60) Provisional application No. 62/249,127, filed on Oct. 30, 2015.

(51) Int. Cl. G08B 17/06

(52) U.S. Cl. CPC G08B 17/06

(57) ABSTRACT

The current invention is a heat detector used to detect fires in out of the way places and places where a standard fire alarm will not work such as garages and attics. The heat detector will have a standalone battery operated heat detectors and will communicate to an alarm when the heat exceeds an. The connection can be either wired or wireless.

### CROSS-REFERENCES TO RELATED APPLICATIONS (IF ANY)

This application claims the priority date of Provisional Application No. 62/249,127 filed on Oct. 30, 2015.

### BACKGROUND

1. Field of the Invention

This invention relates to a fire detection device and system and more particularly one that is designed for use in an attic or garage.

2. Description of Prior Art

If a fire were to start in someone's attic or garage, they wouldn't be aware until it was too late. Fires in attached garages happen for many reasons: Malfunction of a parked automobile, oily rags in a pile, careless disposal of ashes/coals, electrical fault, to name a few.

Once an attached garage is burning, the fire easily attacks the house mainly via the attic. Often residents of the house are not aware of the fire till it breaches the house and sets off smoke alarms, often blocking exit paths. This is also true for potential fires in an attic space. This awareness of the fire can be many minutes after the fire starts and this delay can lead to excessive property damage and possible injury and or death to the occupants of the home. Smoke alarms are common in the market place, however, due to fumes from cars, lawn mower, snow blowers, extreme temperatures, etc. smoke detectors are not acceptable in a garage application.

There is still room for improvement in the art.

### SUMMARY OF THE INVENTION

The current invention is a heat detector used to detect fires in out of the way places and places that a standard fire alarm will not work such as garages and attics. The heat detector will have a standalone battery operated heat detectors set to trip at 194 degrees Fahrenheit. The heat detector

### BRIEF DESCRIPTION OF THE DRAWINGS

Without restricting the full scope of this invention, the preferred form of this invention is illustrated in the following drawings:

FIG. 1 is a view of the current invention;

FIG. 2 shows a connection between the sensor and the alarm; and

FIG. 3 shows the components of the sensor

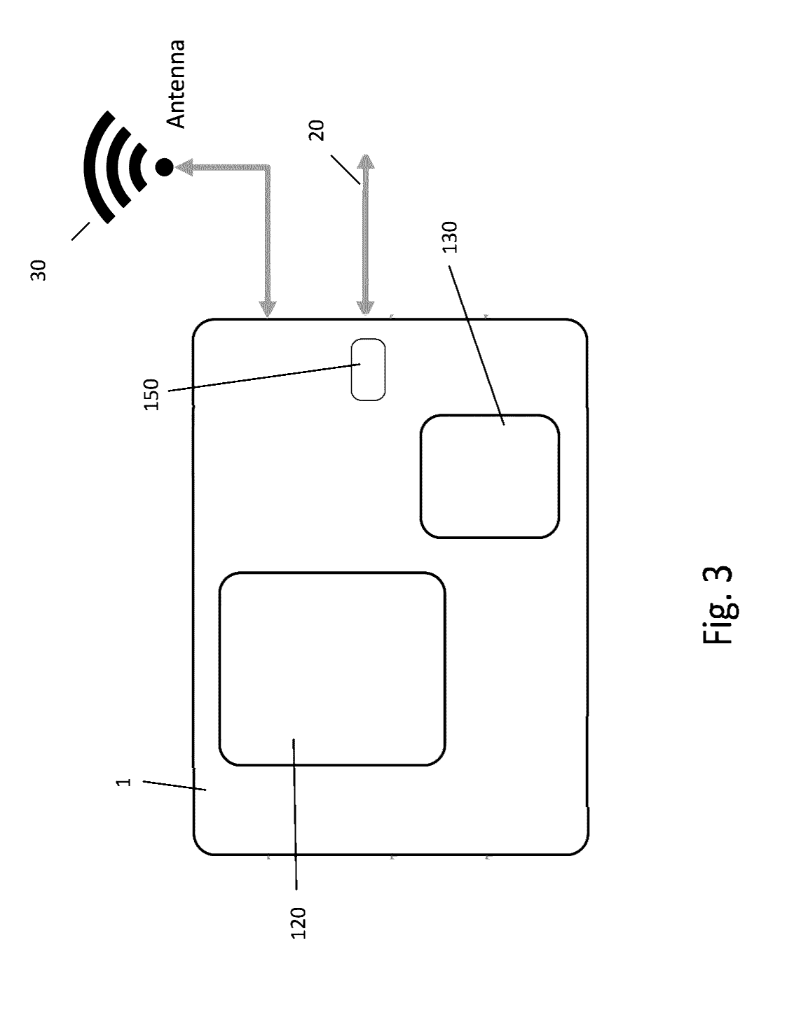

### DESCRIPTION OF THE PREFERRED EMBODIMENT

There are a number of significant design features and improvements incorporated within the invention.

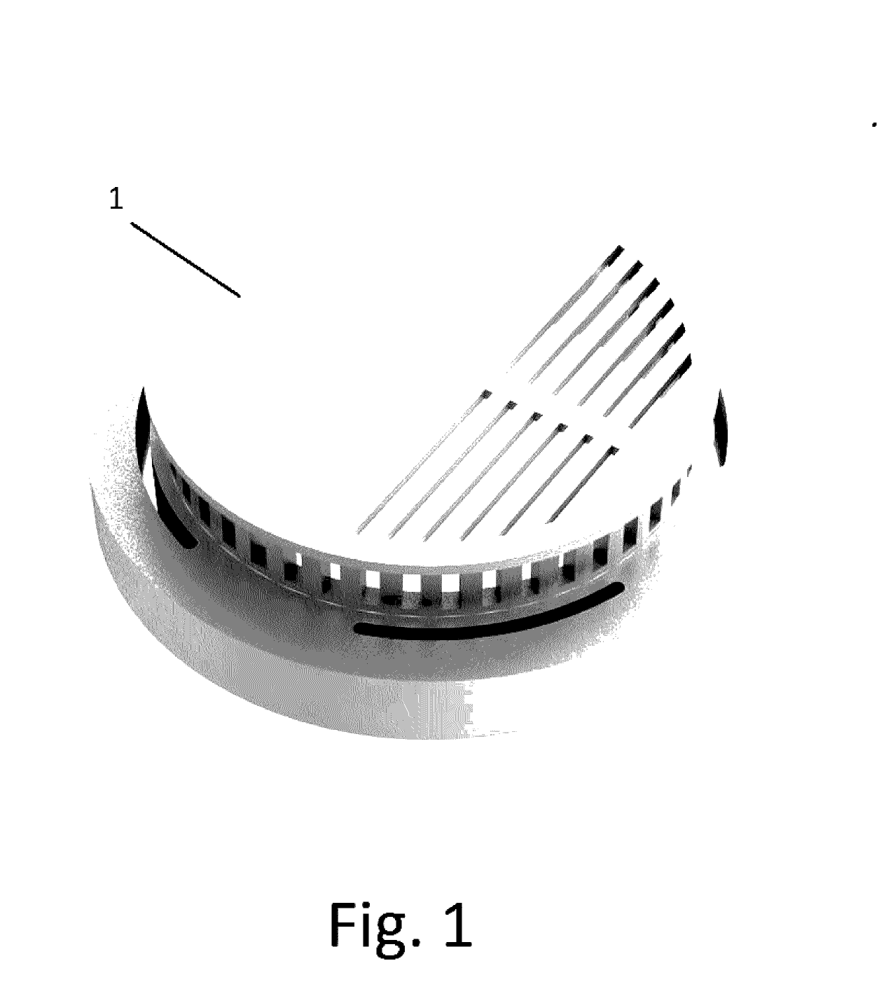

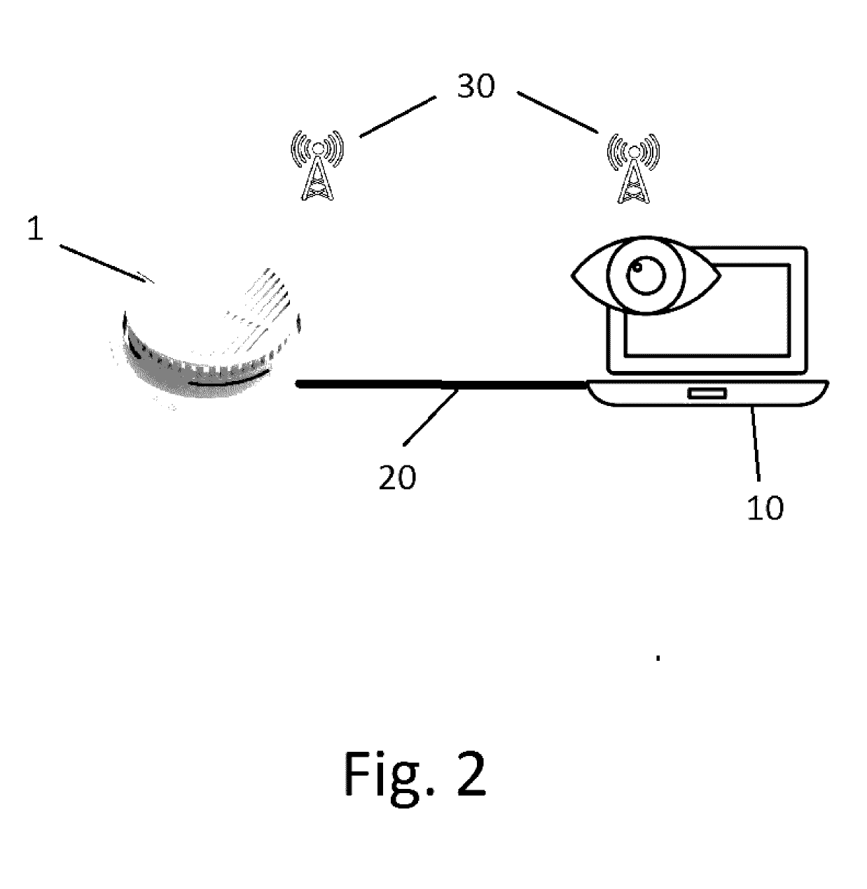

The present invention is a sensor 1, as shown in FIG. 1, that is connected to a alarm 10. The current invention is a first line of protection when it comes to garage and attic fire protection. The two-piece design consists of a sensor 1 to place in the attic and/or garage, and an alarm 10 to place inside the home and/or to a user's phone or a monitoring system as shown in FIG. 2. The sensor 1 is set to trip at a set temperature such as 194 F.

The current invention solves the problem of monitoring an attic or garage for five without the costs or issues with the current monitoring systems.

The components of the invention are a sensor 1 which has a heat sensor 120 that is set for a set temperature which is 194 F degrees in the preferred embodiment, connected to a battery and a communication means such as a wire 20 or wireless means 30. The communication means connect to an alarm 10 which can be a standard alarm the emits a high pitch alarm sound, or a cell phone or alarm monitoring system.

The sensor 1 can be made by taking a conventional battery powered smoke alarm. Disassemble alarm and solder one wire on each contact on the circuit board where the “push to test” button contacts are. Extend these wires out the back and reassemble alarm. Take a heat sensor, such as a 194 degree heat sensor, that has a contact type temperature and rate of rise sensor. Using the thermostat cable, wire the heat sensor to the two wires from the smoke alarm. In the event of a fire the heat sensor will close the electrical circuit sounding the alarm as if the “push to test” button was pressed.

Periodic testing of the alarm can be done using a heat source like a hair dryer to heat the sensor. It is important to do this quickly and only affect the rate of rise part of the sensor.

In the preferred embodiment, the sensor 1 will have terminals 150 designed on to the back of the sensor to allow ease of connecting the sensor to the alarm by a wired connection.

In the preferred embodiment, the sensor 1 will use high end extended temperature batteries such as lithium batteries as the batteries need to handle the high temperature that sets off the alarm.

Essentially this is a cost effective method to monitor you garage and/or attic versus the current solutions on the market are very expensive and require hard wiring

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A fire detection device comprising:
a heat sensitive sensor connected to an alarm.

2. A fire detection device according to claim 1 further comprising:
where the connection is a wire.

3. A fire detection device according to claim 1 further comprising:
where the heat sensitive sensor is connected by a wireless connection.

4. A fire detection device according to claim 1 further comprising:
where the alarm is a fire monitoring system.

5. A fire detection device according to claim 1 further comprising:
where the alarm is a cell phone.

6. A fire detection device according to claim 1 further comprising:
where the sensor is placed in the attic.

7. A fire detection device according to claim 1 further comprising:
where the sensor is placed in a garage.

8. A fire detection device according to claim 1 further comprising:
making the sensor by taking a conventional battery powered smoke alarm, disassemble the smoke alarm, solder one wire on each contact on the circuit board where the “push to test” button contacts are, and wire a heat sensor to the two wires from the smoke alarm.
